(19) United States
(12) Patent Application Publication
(10) Pub. No.: US 2006/0200447 A1
(43) Pub. Date: Sep. 7, 2006

(54) Method and system for managing information on a product

(76) Inventors: Jana H. Jenkins, Raleigh, NC (US); Michelle L. Corbin, Cary, NC (US)

Correspondence Address: HOFFMAN WARNICK & DALESSANDRO LLC, 75 STATE ST, 14TH FLOOR, ALBANY, NY, 12207, US

(21) Appl. No.: 11/073,836

(22) Filed: Mar. 7, 2005

(51) Int. Cl. G06F 17/30

(52) U.S. Cl. 707/2

(57) ABSTRACT

The management of information on a product is provided, in which text information on the product is initially provided for display to a user. In response to a request, graphical information on the product is generated using the product and provided for display to the user. The graphical information can be embedded in the text information or displayed in a separate display window. As a result, the user can selectively determine which graphical information is desired, and the graphical information will be current.

### BACKGROUND OF THE INVENTION

1. Technical Field

The invention relates generally to managing information on a product, and more particularly, to a solution that allows an end user to determine the graphical information, such as one or more screen shots, that are included when the product information is displayed.

2. Background Art

Product information, such as a help manual, a white paper, a press release, etc., frequently includes graphical information to provide the reader with one or more visual references of what is being discussed. For example, for a computer program product, one or more captured panels (i.e., “screen shots”) can be included that illustrate how a particular panel that is being discussed will be displayed when the reader uses the computer program product. The inclusion of such graphical information is intended to provide orientation, reduce confusion, increase understanding, and the like, for the reader.

However, the decision of whether to include graphical information, such as a screen shot, can be complex. In particular, when the product information includes too many panels, a simplistic panel, and/or a poor quality representation of a panel, the reader can become frustrated and/or distracted by the graphical information. Further, as computer program products and their corresponding user interfaces become more dynamic, the likelihood of one or more inconsistencies being present between the product information and that generated by the computer program product increases. Such inconsistencies also can provide a source of frustration and reduce the reader's confidence in the accuracy of the information.

Additional considerations, such as the cost of inclusion, time to include, feasibility of translation, amount of data in the product information, etc., also can impact the decision to include or not include certain graphical information. Further, once included, the product information will require maintenance if the graphical information is to remain accurate as the product changes. In any event, once included, the information is static and cannot be customized according to the desires/requirements for each particular reader.

In light of the above, there exists a need for an improved solution for managing information on a product. To this extent, a need exists for a method and system for managing information on a product that generate graphical information for display to a user in response to a request received from the user.

### SUMMARY OF THE INVENTION

The invention provides an improved solution for managing information on a product. In particular, text information on the product is initially provided for display to a user. In response to a request for graphical information, the graphical information is generated using the product and provided for display to the user. In one embodiment, the product comprises computer program code. A script can be used to generate the graphical information using the product. In any event, the graphical information can be embedded in the text information and/or displayed in a separate display window to the user. As a result, the invention provides an improved solution for managing information on a product that enables the user to selectively display, locate, etc., desired graphical information. Further, the invention provides a solution that ensures that the graphical information is current and/or reduces the storage and communication requirements of information on the product.

A first aspect of the invention provides a method of managing information on a product, the method comprising: providing text information on the product for display to a user; receiving a request for graphical information on the product; generating the graphical information using the product in response to the request; and providing the graphical information for display to the user.

A second aspect of the invention provides a system for managing information on a product, the system comprising: a system for providing text information on the product for display to a user; a system for receiving a request for graphical information on the product; a system for generating the graphical information using the product in response to the request; and a system for providing the graphical information for display to the user.

A third aspect of the invention provides a program product stored on a computer-readable medium, which when executed, manages information on a product, the program product comprising: program code for providing text information on the product for display to a user; program code for receiving a request for graphical information on the product; program code for generating the graphical information using the product in response to the request; and program code for providing the graphical information for display to the user.

A fourth aspect of the invention provides a method of deploying an application for managing information on a product, the method comprising: providing a computer infrastructure being operable to: provide text information on the product for display to a user; receive a request for graphical information on the product; generate the graphical information using the product in response to the request; and provide the graphical information for display to the user.

A fifth aspect of the invention provides computer software embodied in a propagated signal for managing information on a product, the computer software comprising instructions to cause a computer system to perform the following functions: provide text information on the product for display to a user; receive a request for graphical information on the product; generate the graphical information using the product in response to the request; and provide the graphical information for display to the user.

A sixth aspect of the invention provides a rendering product stored on a computer-readable medium, which when executed, displays information on a product, the rendering product comprising: rendering code for displaying text information on the product; rendering code for enabling a user to generate a request for the product to generate graphical information, wherein the request includes an identifier for a graphical panel; rendering code for providing the request for processing; and rendering code for receiving the graphical information in response to the request.

A seventh aspect of the invention provides a computer-readable medium that includes computer program code to enable a computer infrastructure to manage information on a product.

An eighth aspect of the invention provides a business method for managing information on a product.

A ninth aspect of the invention provides a method of generating a system for managing information on a product.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing information on a product;

FIG. 2 shows an illustrative display window for displaying text information;

FIG. 3 shows an illustrative data flow diagram that can be implemented by the various systems shown in FIG. 1;

FIG. 4 shows illustrative method steps that can be implemented to generate graphical information;

FIG. 5 shows a display window displaying text information with embedded graphical information; and

FIG. 6 shows an illustrative display window that displays graphical information in a separate window from text information.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for managing information on a product. In particular, text information on the product is initially provided for display to a user. In response to a request for graphical information, the graphical information is generated using the product and provided for display to the user. In one embodiment, the product comprises computer program code. A script can be used to generate the graphical information using the product. In any event, the graphical information can be embedded in the text information and/or displayed in a separate display window to the user. As a result, the invention provides an improved solution for managing information on a product that enables the user to selectively display, locate, etc., desired graphical information. Further, the invention provides a solution that ensures that the graphical information is current and/or reduces the storage and communication requirements of information on the product.

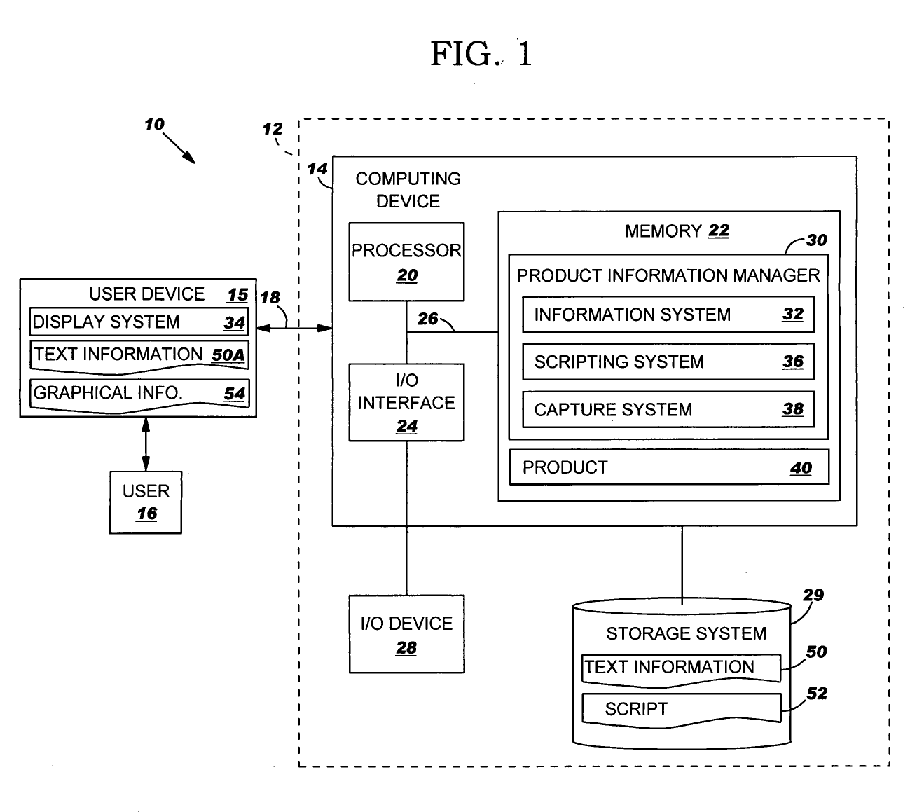

Turning to the drawings, FIG. 1 shows an illustrative system 10 for managing information on a product 40. To this extent, system 10 includes a computer infrastructure 12 that can perform the various process steps described herein for managing information on product 40. In particular, computer infrastructure 12 is shown including a computing device 14 that comprises a product information manager 30, which enables computing device 14 to manage information on product 40 by performing the process steps of the invention.

Computing device 14 is shown including a processor 20, a memory 22, an input/output (I/O) interface 24, and a bus 26. Further, computing device 14 is shown in communication with an external I/O device/resource 28 and a storage system 29. In general, processor 20 executes computer program code, such as product information manager 30, that is stored in memory 22 and/or storage system 29. While executing computer program code, processor 20 can read and/or write data, such as text information 50, to/from memory 22, storage system 29, and/or I/O interface 24. Bus 26 provides a communication link between each of the components in computing device 14. I/O device 28 can comprise any device that enables a user, such as user 16, to interact with computing device 14 or any device that enables computing device 14 to communicate with one or more other computing devices, such as user device 15.

In any event, computing device 14 can comprise any general purpose computing article of manufacture capable of executing computer program code installed by a user 16 (e.g., a personal computer, server, handheld device, etc.). However, it is understood that computing device 14 and product information manager 30 are only representative of various possible computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over a network, via a shared memory, or the like, to perform the various process steps of the invention. In the former case, the network can comprise one or more types of networks (e.g., the Internet, a wide area network, a local area network, a virtual private network, etc.), and communications between the computing devices may utilize various types of communications links and/or transmission techniques (e.g., wired, wireless, etc.).

To this extent, computer infrastructure 12 can further comprise user device 15. User device 15 is shown in communication with computing device 14 over a network 18. Network 18 can comprise any combination of various types of communications links as is known in the art. In one embodiment, user device 15 comprises a personal computing device that is in communication with computing device 14 over a global computer network such as the Internet. Regardless, it is understood that user device 15 can comprise the same components (processor, memory, I/O interface, etc.) as shown for computing device 14. These components have not been separately shown and discussed for brevity.

As previously mentioned and discussed further below, product information manager 30 enables computing device 14 to manage information on product 40. To this extent, product information manager 30 is shown including an information system 32 for providing information on product 40 for display to user 16, a scripting system 36 for generating graphical information 54, such as a graphical panel, using product 40, and a capture system 38 for capturing graphical information 54. Operation of each of these systems is discussed further below. However, it is understood that some of the various systems shown in FIG. 1 can be implemented independently, combined, and/or stored in memory for one or more separate computing devices 14 that communicate over a network. To this extent, user device 15 is shown including a display system 34 for displaying the information on product 40 to user 16. Further, it is understood that some of the systems and/or functionality may not be implemented, or additional systems and/or functionality may be included as part of system 10. For example, display system 34 is an optional part of the invention, which could be implemented on computing device 14 rather than a separate user device 15 as shown.

As previously discussed, the invention provides a solution for managing information on product 40. Product 40 can comprise any type of goods and/or services. In one embodiment, product 40 comprises computer program code, e.g., a software application, a web-based application, or the like. However, it is understood that product 40 is not limited to computer program code, and can comprise any combination of hardware and/or software for which information may be desired and by which graphical information 54 can be generated.

In general, the information on product 40 will comprise text information 50. Text information 50 can comprise a description of various features of product 40, instructions on how to use product 40, and the like. To this extent, text information 50 is frequently developed together with product 40. In particular, when one or more changes are made, features are added, etc., to product 40, text information 50 is updated to reflect the current implementation of product 40. In one embodiment, a user, such as user 16, can use information system 32 to add, delete, modify, etc., text information 50. To this extent, information system 32 can generate and/or display various interfaces that enable user 16 to manage the contents of text information 50 as is known in the art.

Text information 50 can be stored on storage system 29 in any known manner. For example, text information 50 can comprise a set (one or more) of files, in which the data is generated based on a word processor format, a portable document format, and the like. In one embodiment, user 16 operates display system 34 to generate a request for text information 50. The request is communicated to information system 32 via network 18, and information system 32 provides text information 50 for display to user 16 in response to the request. In particular, information system 32 can communicate text information 50 over network 18, display system 34 can store a local copy of text information 50A, and display system 34 can display text information 50A to user 16.

As noted above, network 18 can comprise the Internet or other public network. To this extent, text information 50 can comprise a rendering product that causes user device 15 to display information on product 40. In particular, text information 50 can comprise rendering code, such as markup code and/or program code, which when interpreted by display system 34 and/or executed by user device 15 causes the display of text information 50A. For example, text information 50 can comprise rendering code written in the hypertext markup language (HTML), extensible markup language (XML), or the like, and/or program code written in Java, VBScript, or the like. To this extent, display system 34 can comprise a Web browser software application or the like.

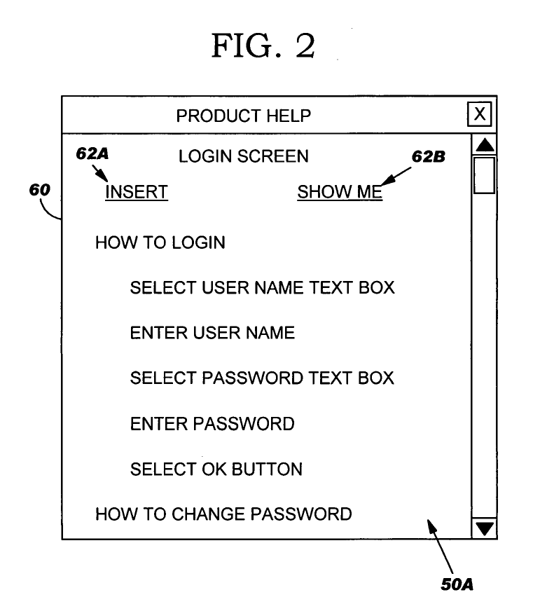

For example, FIG. 2 shows an illustrative display window 60 for displaying text information 50A to user 16 (FIG. 1). As shown, text information 50A can comprise help on product 40 (FIG. 1), e.g., how to login to product 40 using a login screen generated by product 40. As is typical, text information 50A can comprise a series of steps that user 16 can perform to login. In any event, text information 50A is shown including controls 62A, 62B. Controls 62A-B comprise rendering code that enables user 16 to generate an event. The event comprises a request by user 16 for the performance of some desired action. For example, control 62A can enable user 16 to request the insertion of graphical information 54, and control 62B can enable user 16 to request the display of graphical information 54 in a separate display window. It is understood, however, that controls 62A-B are only illustrative, and any user interface control, such as a menu, a button, a dialog box, etc., can be included to enable user 16 to generate the event.

Regardless, referring to both FIGS. 1 and 2, in response to the event, display system 34 and/or the rendering code can generate a request based on the event. In particular, the request can comprise a request for graphical information 54 on product 40. Once generated, display system 34 and/or the rendering code can provide the request for processing by information system 32. To this extent, display system 34 can communicate the request over network 18.

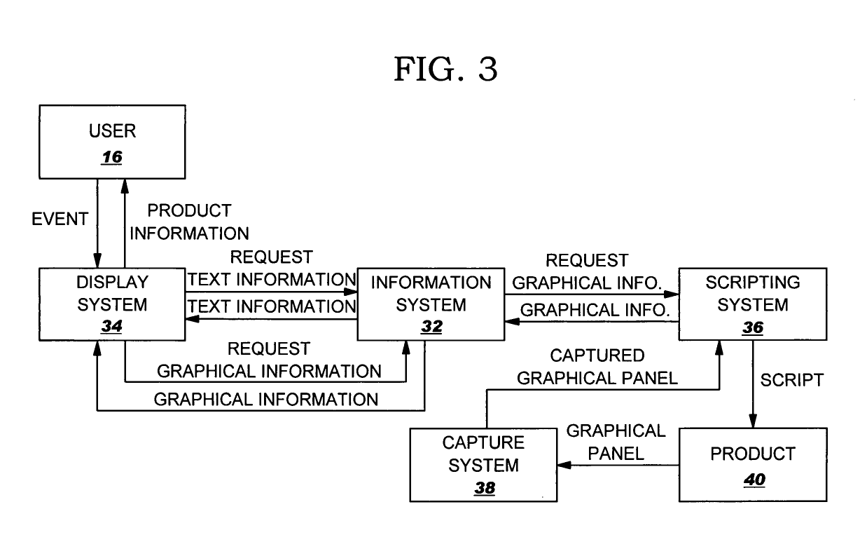

FIG. 3 shows an illustrative data flow diagram that can be implemented by the various systems shown in FIG. 1. Referring to FIGS. 1 through 3, collectively, as previously discussed, in response to an event generated by user 16, display system 34 can request text information 50A from information system 32. In response, information system 32 can provide text information 50A to display system 34, which can display text information 50A (product information) to user 16. While viewing text information 50A, user 16 can generate an event using a control 62A-B. Display system 34 can generate a request for graphical information 54 in response to the event, and provide the request to information system 32.

Information system 32 can forward the request to scripting system 36, which can generate graphical information 54 using product 40 in response to the request. In particular, scripting system 36 can initiate a script 52 based on the request. To this extent, the request can comprise an identifier or the like that corresponds to the desired graphical information 54. In this case, scripting system 36 can select an appropriate script 52 from a set (one or more) of scripts 52 stored in storage system 29 based on the identifier. For example, a set of scripts 52 could be stored and/or indexed using a relational database or the like. In this case, scripting system 36 could select the appropriate script 52 using one or more fields that comprise a unique identifier. Subsequently, scripting system 36 can initiate and process the selected script 52. It is understood that script 52 can be implemented using any type of program and/or scripting language as is known in the art.

In any event, using script 52, product 40 generates the desired graphical information 54. To this extent, script 52 can initially determine if product 40 is currently executing. If not, then scripting system 36 can initiate product 40 using script 52. In particular, script 52 can designate the appropriate product 40 and/or any startup options that are required to enable product 40 to generate graphical information 54 using script 52. Once executing, various commands in script 52 can be implemented by product 40 until the desired graphical information 54 has been generated. For example, when product 40 comprises a computer program product, scripting system 36 can determine if product 40 is executing on computing device 14 and/or another available computing device. Once executing, scripting system 36 can apply script 52 to product 40. In this case, script 52 can comprise a set (one or more) of commands that cause product 40 to generate a desired graphical panel.

Once the graphical information 54, e.g., the graphical panel, has been generated using product 40, capture system 38 can capture the graphical information. In one embodiment, product 40 can render the graphical information on a display device, and capture system 38 can comprise screen capture program code that captures some/all of the current image rendered on the display device and transfers the data into a file or the like that comprises the graphical information. To this extent, capture system 38 can capture the contents of the entire display and/or the contents of a portion of the display. For example, capture system 38 can capture a portion of the display that is defined by the area and location of the desired graphical panel. In this case, the captured graphical panel can then be provided to scripting system 36, which can provide the data to information system 32 as the graphical information.

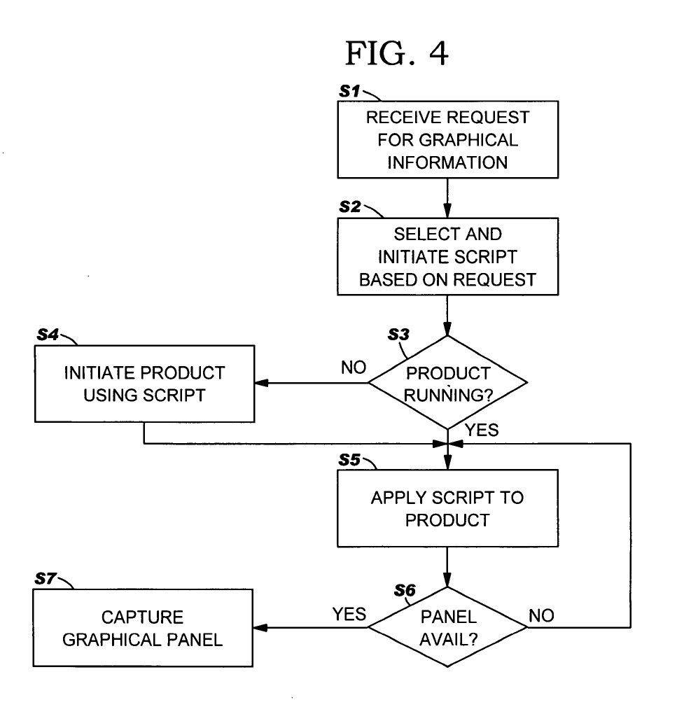

To summarize, FIG. 4 shows illustrative method steps that can be implemented to generate the requested graphical information 54 (FIG. 1) when graphical information 54 comprises a graphical panel generated by product 40 (FIG. 1). In particular, in step S1, a request for the graphical panel is received. In step S2, a script 52 (FIG. 1) is selected and initiated based on the request. In step S3, it is determined whether product 40 is executing. If not, in step S4, product 40 is initiated using script 52. In either case, in step S5, script 52 is applied to product 40. In step S6, script 52 determines whether the requested graphical panel is available. If not, the script is continued to be applied in step S5. Otherwise, in step S7, the graphical panel is captured. It is understood that the various steps are only illustrative and numerous alternatives are possible. Further, one or more additional steps can be included. For example, script 52 can also close product 40 once the graphical panel has been captured.

Returning to FIGS. 1 through 3, information system 32 can provide graphical information 54 for display to user 16 in response to the request. In one embodiment, information system 32 communicates graphical information 54 over network 18 for use by rendering code included in text information 50A. Once received, the rendering code displays the graphical information to user 16. To this extent, display system 34 may interpret/process the rendering code to display graphical information 54. Graphical information 54 can be displayed in any known manner.

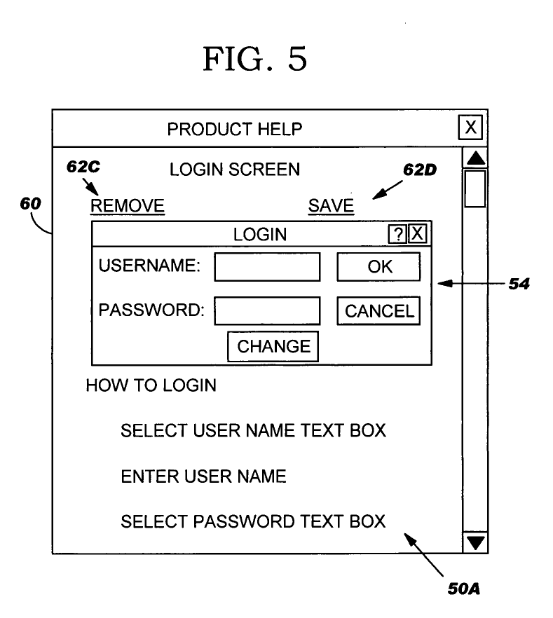

For example, by selecting control 62A, user 16 can request that rendering code and/or display system 34 embed graphical information 54 in text information 50A and subsequently display the text information 50A with the embedded graphical information 54. To this extent, FIG. 5 shows display window 60 after having been updated to display text information 50A with the embedded graphical information 54. In particular, display window 60 displays graphical information 54 below where control 62A was located in text information 50A, and text information 50A has been shifted down to appear below graphical information 54. It is understood, however, that graphical information 54 can be embedded in text information 50A in any location relative to text information 50A. To this extent, graphical information 54 could be embedded adjacent to the portion of text information 50A that references the graphical information 54.

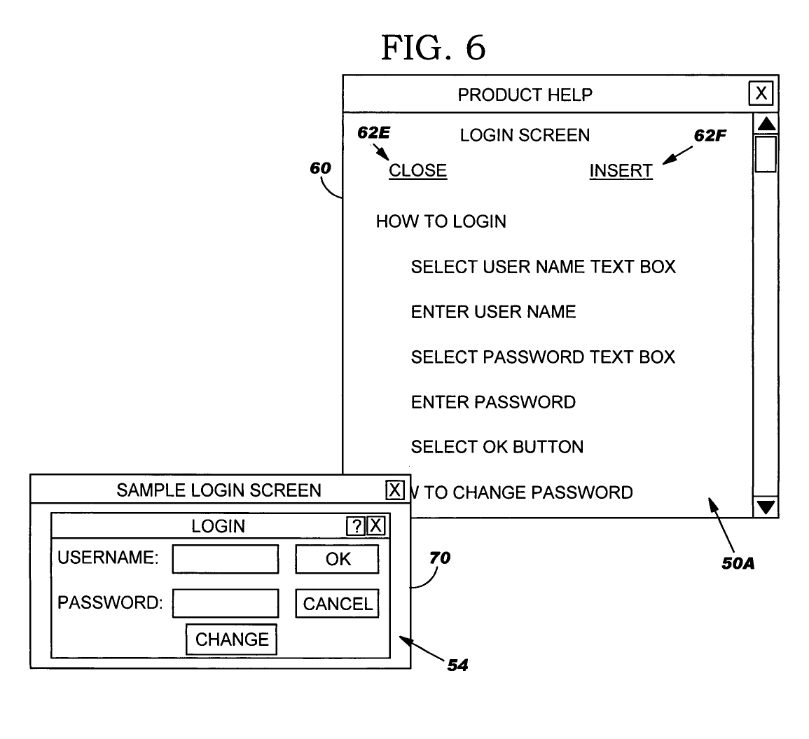

Returning to FIG. 2, control 62B can enable user 16 (FIG. 1) to request that rendering code and/or display system 34 display graphical information 54 in a separate display window from display window 60. To this extent, FIG. 6 shows an illustrative display window 70 that displays graphical information 54. In this case, rendering code and/or display system 34 can generate a new display window 70 and display graphical information 54 within the new display window 70. In one embodiment, rendering code and/or display system 34 generates display window 70 before graphical information 54 is received. In this case, display window 70 can comprise rendering code that generates the request, receives the graphical information 54, and displays the graphical information 54. Alternatively, display window 70 can be generated after graphical information 54 is received and provided with graphical information 54 for display. In any event, display window 70 allows user 16 (FIG. 1) to selectively locate graphical information 54 with respect to text information 50A.

After graphical information 54 has been displayed, rendering code included in text information 50A and/or display system 34 (FIG. 1) can enable user 16 (FIG. 1) to select various other functions. For example, returning to FIG. 5, control 62C can enable user 16 to remove graphical information 54 from display window 60. Additionally, control 62D can enable user 16 to save text information 50A with the embedded graphical information 54 for future reference, printing, or the like. Similarly, FIG. 6 shows a control 62E that allows user 16 to select to close display window 70, and a control 62F that enables user 16 to select to insert graphical information 54 in text information 50A rather than display it in a separate display window 70. It is understood that controls 62A-F are only illustrative and various other functions can be provided to user 16. For example, user 16 can select to print text information 50A with the embedded graphical information 54, display graphical information 54 currently embedded in text information 50A in a new display window, etc.

It is understood that the information on product 40 can comprise any type of information. In one embodiment, text information 50 comprises instructions on the use of product 40 and/or a white paper, advertising, or the like, describing various features of product 40. In these cases, graphical information 54 would typically comprise a graphical panel that is being described and/or referenced in text information 50. In another embodiment, text information 50 can comprise various information about the performance of product 40, computing device 14, computer infrastructure 12, and/or the like. In this case, graphical information 54 could comprise a chart or other type of graphical data that comprises current performance data. However, these applications are only illustrative and the invention can be applied to various other applications as will be recognized.

While shown and described herein as a method and system for managing information on a product, it is understood that the invention further provides various alternative embodiments. For example, in one embodiment, the invention provides a computer-readable medium that includes computer program code to enable a computer infrastructure to manage information on a product. To this extent, the computer-readable medium includes program code, such as product information manager 30 (FIG. 1) and/or display system 34 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 29 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to manage information on a product as described above. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for managing information on a product. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of managing information on a product, the method comprising:
providing text information on the product for display to a user;
receiving a request for graphical information on the product;
generating the graphical information using the product in response to the request; and
providing the graphical information for display to the user.

2. The method of claim 1, further comprising displaying the text information to the user.

3. The method of claim 1, wherein the receiving step includes:
obtaining an event generated by the user; and
generating a request based on the event.

4. The method of claim 3, wherein the receiving step further includes communicating the request over a network.

5. The method of claim 1, wherein the generating step includes:
initiating a script based on the request;
generating a graphical panel with the product using the script; and
capturing the graphical panel, wherein the captured graphical panel comprises the graphical information.

6. The method of claim 5, further comprising initiating the product using the script.

7. The method of claim 5, further comprising displaying the graphical panel, wherein the capturing step comprises a screen capture of a display.

8. The method of claim 1, further comprising displaying the graphical information to the user.

9. The method of claim 8, wherein the displaying step comprises:
generating a new display window; and
displaying the graphical information within the new display window.

10. The method of claim 8, wherein the displaying step comprises:
embedding the graphical information in the text information; and
displaying the text information with the embedded graphical information.

11. The method of claim 1, further comprising storing the graphical information.

12. The method of claim 1, wherein the product comprises computer program code.

13. A method of generating a system for managing information on a product, the method comprising:
obtaining a computer infrastructure; and
for each of the steps of claim 1, deploying a means for performing the step to the computer infrastructure.

14. A computer-readable medium for enabling a computer infrastructure to manage information on a product, the computer-readable medium comprising computer program code for performing the method steps of claim 1.

15. A system for managing information on a product, the system comprising:
a system for providing text information on the product for display to a user;
a system for receiving a request for graphical information on the product;
a system for generating the graphical information using the product in response to the request; and
a system for providing the graphical information for display to the user.

16. The system of claim 15, wherein the system for generating includes:
a system for initiating a script based on the request;
a system for generating a graphical panel with the product using the script; and
a system for capturing the graphical panel, wherein the captured graphical panel comprises the graphical information.

17. The system of claim 15, wherein the product comprises computer program code.

18. The system of claim 15, further comprising a system for displaying the text information and the graphical information to the user.

19. The system of claim 15, further comprising a system for initiating the product.

20. A rendering product stored on a computer-readable medium, which when executed, displays information on a product, the rendering product comprising:
rendering code for displaying text information on the product;
rendering code for enabling a user to generate a request for the product to generate graphical information, wherein the request includes an identifier for a graphical panel;
rendering code for providing the request for processing; and
rendering code for receiving the graphical information in response to the request.

21. The rendering product of claim 20, further comprising:
rendering code for generating a new display window; and
rendering code for displaying the graphical information within the new display window.

22. The rendering product of claim 20, further comprising:
rendering code for embedding the graphical information in the text information; and
rendering code for displaying the text information with the embedded graphical information.
